(19) United States
(12) Patent Application Publication
(10) Pub. No.: US 2014/0300451 A1
(43) Pub. Date: Oct. 9, 2014

(54) VEHICLE CONFIGURATION SYSTEM

(71) Applicant: DEERE & COMPANY, Moline, IL (US)

(72) Inventors: ROBERT J. REISING, DES MOINES, IA (US); MICHAEL L. GARDNER, ANKENY, IA (US); ROBERT E. LORENTZEN, BONDURANT, IA (US); GARRY E. BAXTER, ANKENY, IA (US); ADAM J. ROYAL, ANKENY, IA (US); KENT A. KLEMME, ANKENY, IA (US); BRADLEY J. HITCHLER, BAXTER, IA (US)

(73) Assignee: Deere & Company, Moline, IL (US)

(21) Appl. No.: 13/859,306

(22) Filed: Apr. 9, 2013

(51) Int. Cl. G06K 19/07

(52) U.S. Cl. CPC G06K 19/0724
USPC 340/10.1

(57) ABSTRACT

A system for configuring a vehicle that comprises a feature. An electronic tag is coupleable to the feature. The system comprises a reader in communication with the electronic tag. The reader is configured to perform at least one of detecting a presence of the electronic tag, detecting an absence of the electronic tag, and receiving a feature data communicated by the electronic tag. A processor is in communication with the reader. The processor is operable to configure the vehicle based on at least one of the presence of the electronic tag, the absence of the electronic tag, and the feature data.

### FIELD OF THE DISCLOSURE

The present disclosure generally relates to vehicles, and more particularly to a system for configuring vehicles.

### BACKGROUND OF THE DISCLOSURE

In order to configure a vehicle comprising various features, vehicles commonly include software that requires software updates depending on the features installed. Updating the software is commonly a manual process.

### SUMMARY OF THE DISCLOSURE

In one embodiment, a system for configuring a vehicle is disclosed. The vehicle comprises a feature. An electronic tag is coupleable to the feature. The system comprises a reader in communication with the electronic tag. The reader is configured to perform at least one of detecting a presence of the electronic tag, detecting an absence of the electronic tag, and receiving a feature data communicated by the electronic tag. A processor is in communication with the reader. The processor is operable to configure the vehicle based on at least one of the presence of the electronic tag, the absence of the electronic tag, and the feature data.

In another embodiment, a method for configuring a vehicle is disclosed. The vehicle comprises a feature. An electronic tag is coupleable to the feature. The method comprises providing a reader in communication with the electronic tag. The reader is configured to perform at least one of detecting a presence of the electronic tag, detecting an absence of the electronic tag, and receiving a feature data communicated by the electronic tag. The method comprises communicating with the reader using a processor and configuring the vehicle based on at least one of the presence of the electronic tag, the absence of the electronic tag, and the feature data.

In yet another embodiment, an agricultural vehicle is disclosed. The agricultural vehicle comprises a feature. A RFID tag is coupleable to the feature. The agricultural vehicle comprises a system. The system comprises a RFID reader in communication with the RFID tag. The RFID reader is configured to perform at least one of detecting a presence of the RFID tag, detecting an absence of the RFID tag, and receiving a feature data communicated by the RFID tag. A processor is in communication with the RFID reader. The processor is operable to configure the agricultural vehicle based on at least one of the presence of the RFID tag, the absence of the RFID tag, and the feature data.

Other features and aspects will become apparent by consideration of the detailed description and accompanying drawings.

### BRIEF DESCRIPTION OF THE DRAWINGS

FIG. 1 is a side view of a vehicle according to one embodiment.

FIG. 2 is a front view of the vehicle of FIG. 1.

FIG. 3 is a schematic of an illustrative system for configuring a vehicle.

FIG. 4 is a schematic of an illustrative system of another embodiment for configuring a vehicle.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

### DETAILED DESCRIPTION

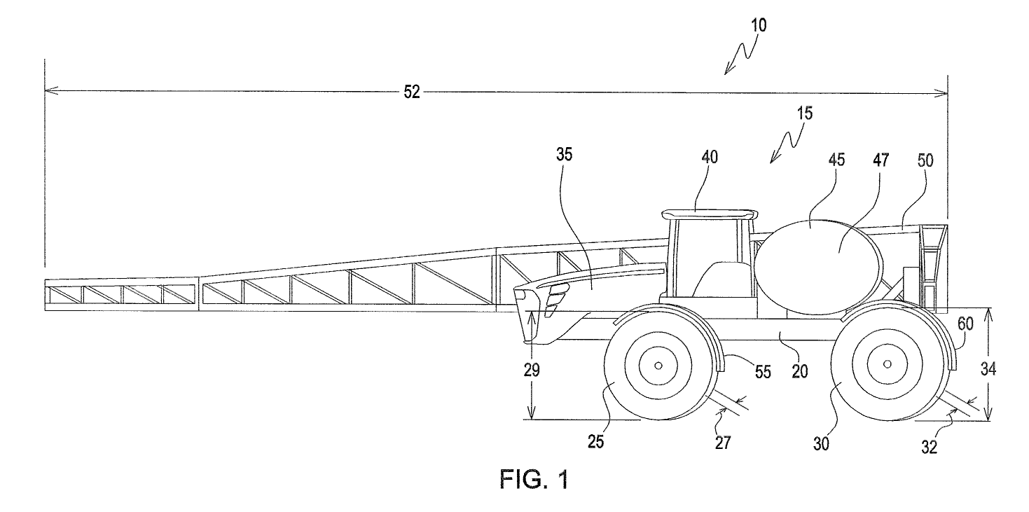

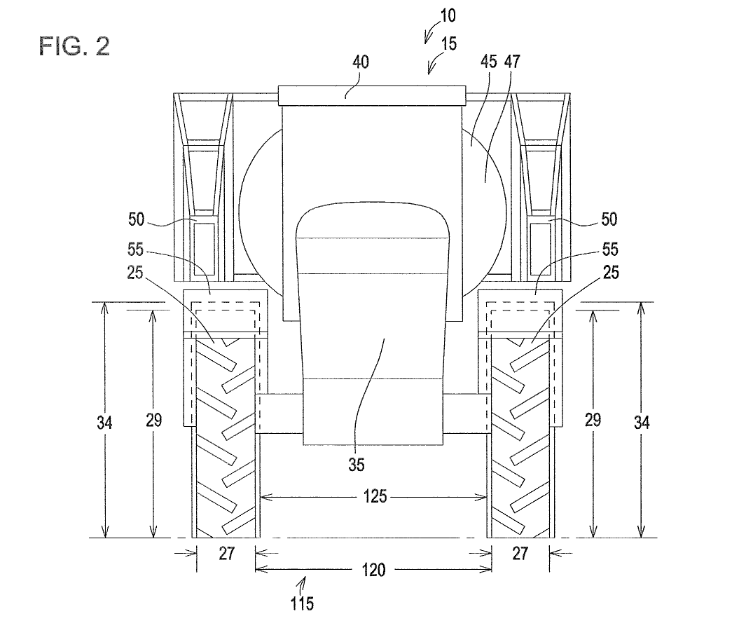

FIGS. 1 and 2 illustrate a vehicle 10. The illustrated vehicle 10 is an agricultural vehicle 15 configured for spraying crops. Other types of vehicles 10 are contemplated by this disclosure (e.g., on-road vehicles). The agricultural vehicle 15 comprises a frame 20. The frame 20 is supported by at least one front wheel 25. The front wheel 25 comprises a front wheel width 27 and a front wheel diameter 29. The frame is also supported by at least one rear wheel 30. The rear wheel 30 comprises a rear wheel width 32 and a rear wheel diameter 34. A hood 35 is coupleable to the frame 20. An operator station 40 is also coupleable to the frame 20. A tank 45 comprising a volume 47 for storing a treatment (e.g., chemical) to be dispensed is coupleable to the frame 20. A boom 50 comprising a length 52 is coupleable to the frame 20 and configured for dispensing the treatment. At least one front fender 55 is coupleable to the frame 20 adjacent the front wheel 25. At least one rear fender 60 is coupleable to the frame 20 adjacent the rear wheel 30.

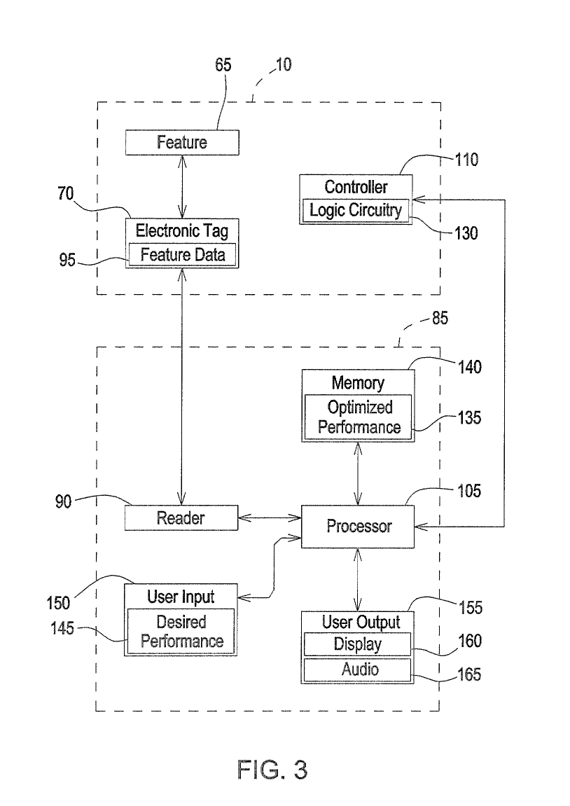

With reference to FIG. 3, the vehicle 10 comprises a feature 65. The feature 65 may be any aspect of the vehicle 10 that may be removed and/or replaced with an alternate aspect that may require the vehicle 10 to function in another manner. For example, the illustrated feature 65 may be the front wheel 25, the rear wheel 30, the tank 45, or the boom 50 of the agricultural vehicle 15 of FIGS. 1 and 2. Alternate front wheels 25 may have different front wheel widths 27 and/or different front wheel diameters 29. Alternate rear wheels 30 may have different rear wheel widths 32 and/or different rear wheel diameters 34. Alternate tanks 45 may have different volumes 47. Alternate booms 50 may have different lengths 52. Other features 65 are contemplated by this disclosure (e.g., engine).

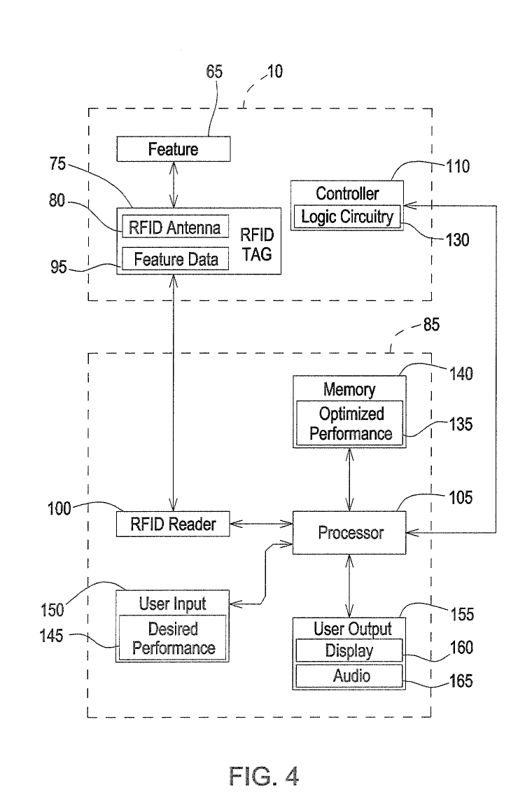

Referring to FIG. 3, an electronic tag 70 is coupleable to the feature 65. With reference to FIG. 4, the illustrated electronic tag 70 is a RFID tag 75. The RFID tag 75 may be an active tag that includes an internal power source or a passive tag that is energized by a field created by an RFID reader. The RFID tag 75 may comprise a RFID antenna 80.

With reference to FIG. 3, a system 85 for configuring the vehicle 10 comprises a reader 90. The reader 90 is in communication with the electronic tag 70. The reader 90 is configured to perform at least one of detecting a presence of the electronic tag 70, detecting an absence of the electronic tag 70, and receiving a feature data 95 communicated by the electronic tag 70. Referring to FIG. 4, the illustrated reader 90 is a RFID reader 100.

With reference to FIG. 3, the system 85 comprises a processor 105. The processor 105 is in communication with the reader 90 and operable to configure the vehicle 10 by communicating with a controller 110 coupled to the vehicle 10. The processor 105 configures the vehicle 10 based on at least one of the presence of the electronic tag 70, the absence of the electronic tag 70, and the feature data 95. Illustratively, the processor 105 is operable to configure the vehicle 10 by optimizing a wheel spacing 115 (FIG. 2), such as a front wheel spacing 120, to prevent the front wheels 25 from contacting at least one of the frame 20 and the front fenders 55. Alternatively, the processor 105 is operable to configure the vehicle 10 by optimizing a rear wheel spacing 125 to prevent the rear wheels 30 from contacting at least one of the frame 20 and the rear fenders 60. This disclosure also contemplates optimizing spacing between the front wheels 25 and the front fenders 55 and a spacing between the rear wheels 30 and the rear fenders 60.

The processor 105 is operable to configure the vehicle 10 by optimizing a configuration of a logic circuitry 130 of the controller 110 to achieve an optimized performance 135 that may be stored in a memory 140. Alternatively, the processor 105 is operable to configure the vehicle 10 to achieve a desired performance 145 provided via a user input 150 (e.g., keyboard, touch screen, voice recognition) or stored in the memory 140.

The optimized performance 135 and the desired performance may be communicated to an operator via a user output 155. The user output 155 may be a display 160, an audio device 165, or other device.

In operation, the electronic tag 70 may be coupled to the feature 65. The reader 90 communicates with the electronic tag 70 if it is coupled to the feature 65. The reader 90 performs at least one of detecting a presence of the electronic tag 70, detecting an absence of the electronic tag 70, and receiving a feature data 95 communicated by the electronic tag 70. The processor 105 communicates with the reader 90 and configures the vehicle 10 based on at least one of the presence of the electronic tag 70, the absence of the electronic tag 70, and the feature data 95. For example, if a front wheel 25 of a given front wheel width 27 is replaced by a front wheel 25 having a front wheel width 27 that is greater, the front wheel spacing 120 may have to be changed in order to minimize the front wheel 25 contact with the frame 20 and yet not protrude outside the front fender 55 excessively. Alternatively, if a front wheel 25 of a given front wheel diameter 29 is replaced by a front wheel 25 having a front wheel diameter 29 that is greater, the front wheel spacing 120 or the spacing between the front wheel 25 and the front fender 55, may have to be changed in order to minimize the front wheel 25 contact with the frame 20 or the front fender 55.

Various features are set forth in the following claims.

What is claimed is:

1. A system for configuring a vehicle comprising a feature and an electronic tag coupleable to the feature, the system comprising:
a reader in communication with the electronic tag, the reader configured to perform at least one of detecting a presence of the electronic tag, detecting an absence of the electronic tag, and receiving a feature data communicated by the electronic tag; and
a processor in communication with the reader, the processor operable to configure the vehicle based on at least one of the presence of the electronic tag, the absence of the electronic tag, and the feature data.

2. The system of claim 1, wherein the electronic tag is a RFID tag and the reader is a RFID reader.

3. The system of claim 2, wherein the RFID tag comprises a RFID antenna.

4. The system of claim 1, wherein the feature is a wheel and the feature data communicates at least one of a width of the wheel and a diameter of the wheel.

5. The system of claim 4, wherein the processor is operable to configure the vehicle by optimizing a wheel spacing to prevent the wheel from contacting at least one of a frame of the vehicle and a fender of the vehicle.

6. The system of claim 1, wherein the processor is operable to configure the vehicle by optimizing a logic circuitry configuration of the vehicle.

7. The system of claim 1, wherein the vehicle is an agricultural vehicle.

8. The system of claim 1, wherein the processor is operable to configure the vehicle to achieve at least one of a desired performance and an optimized performance and communicate via a user output.

9. The system of claim 8, wherein the desired performance is provided via at least one of a user input and a memory.

10. A method for configuring a vehicle comprising a feature and an electronic tag coupleable to the feature, the method comprising:
providing a reader in communication with the electronic tag, the reader configured to perform at least one of:
detecting a presence of the electronic tag,
detecting an absence of the electronic tag, and
receiving a feature data communicated by the electronic tag;
communicating with the reader using a processor; and
configuring the vehicle based on at least one of the presence of the electronic tag, the absence of the electronic tag, and the feature data.

11. The method of claim 1, wherein the electronic tag is a RFID tag and the reader is a RFID reader.

12. The method of claim 1, wherein the feature is a wheel and the feature data communicates at least one of a width of the wheel and a diameter of the wheel.

13. The method of claim 1, wherein the processor is operable to configure the vehicle by optimizing a wheel spacing to prevent the wheel from contacting at least one of a frame of the vehicle and a fender of the vehicle.

14. An agricultural vehicle comprising:
a feature;
a RFID tag coupleable to the feature;
a system comprising a RFID reader in communication with the RFID tag, the RFID reader configured to perform at least one of detecting a presence of the RFID tag, detecting an absence of the RFID tag, and receiving a feature data communicated by the RFID tag, and a processor in communication with the RFID reader, the processor operable to configure the agricultural vehicle based on at least one of the presence of the RFID tag, the absence of the RFID tag, and the feature data.

15. The agricultural vehicle of claim 14, wherein the feature is a wheel and the feature data communicates at least one of a width of the wheel and a diameter of the wheel.

16. The agricultural vehicle of claim 15, wherein the processor is operable to configure the vehicle by optimizing a wheel spacing to prevent the wheel from contacting at least one of a frame of the vehicle and a fender of the vehicle.

17. The agricultural vehicle of claim 14, wherein the processor is operable to configure the agricultural vehicle by optimizing a logic circuitry configuration of the agricultural vehicle.

18. The agricultural vehicle of claim 14, wherein the processor is operable to configure the agricultural vehicle to achieve at least one of a desired performance and an optimized performance.

19. The agricultural vehicle of claim 14, wherein the feature is a tank and the feature data communicates a volume of the tank.

20. The agricultural vehicle of claim 14, wherein the feature is a boom and the feature data communicates a length of the boom.
